(19) United States
(12) Patent Application Publication
(10) Pub. No.: US 2005/0215235 A1
(43) Pub. Date: Sep. 29, 2005

(54) Security system, portable electronic device and security method

(75) Inventor: Masashi Masuda, Kawagoe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CITIZEN WATCH CO., LTD.

(21) Appl. No.: 11/082,696

(22) Filed: Mar. 18, 2005

(30) Foreign Application Priority Data
Mar. 25, 2004 (JP) 2004-89358

(51) Int. Cl. H04M 1/66

(52) U.S. Cl. 455/412.1; 455/411

(57) ABSTRACT

An object of the present invention is to provide a security system, a portable electronic device and a security method, capable of efficiently controlling the states of a plurality of information devices, using at least one portable electronic device. The security system comprises a portable electronic device including a first storage unit in which an unique identification data is stored and a first transmission unit that transmits the identification data, and information device including a receiving unit that receives the identification data from the portable electronic device, a second transmission unit that transmits data over a network, a second storage unit in which predetermined identification data and the address of the other information device are stored, and a control unit that transmits a use enabling signal to the address over the network when the identification data corresponds with the predetermined identification data.

### FIELD OF THE INVENTION

The present invention relates to a security system a portable electronic device and a security method, for controlling the state of an information device, using a portable electronic device.

### BACKGROUND OF THE INVENTION

When a user uses a personal computer (PC) or the like to enter highly confidential information or create a document, data stored in the PC must be protected from being seen, downloaded, altered, or deleted, by a third party without permission, after the user leaves his/her PC.

A security system composed of a portable electronic device that transmits identification data and a PC capable of receiving the identification data from the portable electronic device is known (see JP-A-2003-203287). In this type of system, the identification data to be transmitted from the portable electronic device is registered in the PC in advance. When the PC receives the identification data registered in advance, the PC becomes usable. When identification data other than the identification data registered in advance is received or no identification data is received (because the portable electronic device is located away from the PC), the PC is not usable. Namely, when the authorized user holding the portable electronic device is near the PC, the PC becomes usable. However, when the authorized user leaves the PC, the PC is not usable so that it cannot be illegally used by a third party.

However, a plurality of systems each comprising a portable electronic device and a PC may be located in one place. Moreover, a receiving zone within which each PC can receive identification or authentication data is several meters wide. For example, when seven systems are located in one place, if the PCs are located close to one another, identification data items sent from portable electronic devices owned by authorized users may interfere with one another.

Assume that a plurality of systems is disposed in a room and managed by a manager. In this case, when the manager leaves the room, processing being performed by all the systems must be suspended, from the viewpoint of security. In order to overcome this inconvenience, not only the manager but also users own respective portable electronic devices and the PCs are each designed to include a receiving unit that receives identification data sent from the portable electronic device. However, this leads to an increase in the cost.

A plurality of systems may share the same identification data, and one portable electronic device owned by a manager may be used to control all the systems. However, in order to appropriately receive identification data from the one portable electronic device, the positions at which the PCs are located must be determined carefully. The freedom in arranging PCs is lost.

### SUMMARY OF THE INVENTION

Accordingly, an object of the present invention is to provide a security system, a portable electronic device and a security method capable of solving the foregoing problems.

Another object of the present invention is to provide a security system, a portable electronic device and a security method in which the states of a plurality of information devices can be efficiently controlled by using at least one portable electronic device.

Still another object of the present invention is to provide a security system, a portable electronic device and a security method capable of grasping the current position of a portable electronic device to be used to control the states of a plurality of information devices.

A security system in accordance with the present invention comprises a portable electronic device that includes a first storage unit in which a unique identification data is stored and a first transmission unit that transmits the identification data and
an information device that includes a receiving unit which receives the identification data from the portable electronic device, a second transmission unit that transmits data over a network, a second storage unit in which predetermined identification data and the address of the other information device are stored, and a control unit transmits an enabling signal to the address over the network when the identification data corresponds with the predetermined identification data.

Preferably, the information device included in the security system, in accordance with the present invention, has an operating unit and the control unit starts the receiving unit in response to a operation performed on the operating unit. The control unit included in the information device starts the receiving unit by being triggered by a operation performed on the operating unit. The power supply of the receiving unit is turned on only when reception is needed. This will prove effective in reducing power consumption.

More preferably, identifying information on the information device is stored in the second storage unit included in the security system in accordance with the present invention, and the control unit controls the second transmission unit so as to transmit the identifying information of the information device and identification data to the address over the network. Since the identifying information on the information device (master PC) and the identification data are transmitted from the information device (master PC) to the other information device (slave PC). The other information device can verify which portable electronic device has transmitted the identification data with which has made it usable.

More preferably, the information device included in the security system in accordance with the present invention further comprises a display unit and a second receiving unit that receives information from the portable electronic device over the network, and the control unit displays the information of the portable electronic device received by the second receiving unit on the display unit when the identification data received by the receiving unit does not correspond with the predetermined identification data. The information from the portable electronic device such as the current location of the manager is displayed as a screen saver or the like on the manager's electronic device.

More preferably, the other information device included in the security system, in accordance with the present invention, comprises a third receiving unit that receives the identifying information of the information device and the identification data over the network, a third storage unit, and a second control unit that stores in the third storage unit the received identifying information of the information device in association with the received identification data. A database in which the identifying information of the information device (master PC) is associated with the identification data is created in the other information device (slave PC).

More preferably, the second control unit included in the security system in accordance with the present invention holds the other information device unusable when a enabling signal is not received. If the manager owing the portable electronic device leaves the information device (master PC), the other information device (slave PC) becomes unusable. Thus, leakage of secret information is prevented from occurring during absence of the manager.

More preferably, the other information device included in the security system in accordance with the present invention further comprises a display unit, and the second control unit displays the information of the portable electronic device based on identification data received on the second display unit when the other information device is not usable. The information on the portable electronic device such as the current location of the manager is displayed as a screen saver or the like on the other information device that is not usable.

According to the present invention, depending on identification data of a portable electronic device owned by the manager lying within a receiving zone within which one information device (master PC) can receive data, the other information device (slave PC) can be made usable. This obviates the necessity of including a receiving unit, which receives identification data sent from any other portable electronic device, in each other information device.

According to the present invention, depending on identification data from a portable electronic device, owned by a manager, within a receivable zone within which one information device (master PC) can receive data, the other information device (slave PC) can be made usable. Consideration need not be taken into a receiving condition under which data is received from the manager's portable electronic device. The freedom in arranging the other information devices improves.

According to the present invention, identifying information on the information device (master PC) is shared with the other information devices (slave PC and other master PCs) on a network. Any information device connected on the network can search the current position of the portable electronic device. If the results of search are displayed, the manager's current location (destination) can be immediately reported to others.

A security method in accordance with the present invention comprising the steps of transmitting an identification data in the potable electronic device, receiving the identification data in a receiving unit of the first information device, and transmitting an enabling signal to the second information device over a network according to a stored address when the receiving identification data corresponds with a predetermined identification data, in the first information device.

Preferably, the security method further comprising the step of starting the receiving unit in response to an operation performed on the operating unit, in the first information device.

More preferably, the security method further comprising the step of transmitting an identifying information of the first information device to the second information device over the network according to the stored address, in the first information device.

More preferably, the security method further comprising the step of displaying the information of the potable electronic device transmitted the received identification data on the display unit when the received identification data does not correspond with the predetermined identification, in the first information device.

More preferably, the security method further comprising the step of receiving an identification information of the first information device and the identification data over the network, in the second information device.

More preferably, the security method further comprising the step of keeping the second information device not usable when the enabling signal is not received from the first information device, in the second information device.

### BRIEF DESCRIPTION OF THE DRAWINGS

FIG. 1 is a schematic block diagram of a security system in accordance with the present invention;

FIG. 2 shows an example of arrangement of PC terminals in which the security system in accordance with the present invention is adopted;

FIG. 3 shows an example of arrangement of PC terminals in which the security system in accordance with the present invention is adopted;

FIG. 4 is an explanatory diagram outlining actions to be performed in the security system in accordance with the present invention;

FIG. 5 is a flowchart describing an example of actions to be performed by a portable electronic device;

FIG. 6 is a flowchart describing an example of actions to be performed by a master PC terminal;

FIG. 7 is a flowchart describing an example of actions to be performed by a slave PC terminal;

FIG. 8 shows an example of a network information database;

FIG. 9 is a flowchart describing another example of actions to be performed by the master PC terminal;

FIG. 10 shows an example of a destination display screen image;

FIG. 11A shows an example of a manager search screen image; and

FIG. 11B and FIG. 11C show examples of a results-of-search screen image.

### DESCRIPTION OF THE PREFERRED EMBODIMENTS

Referring to the drawings, a security system in accordance with the present invention will be described below.

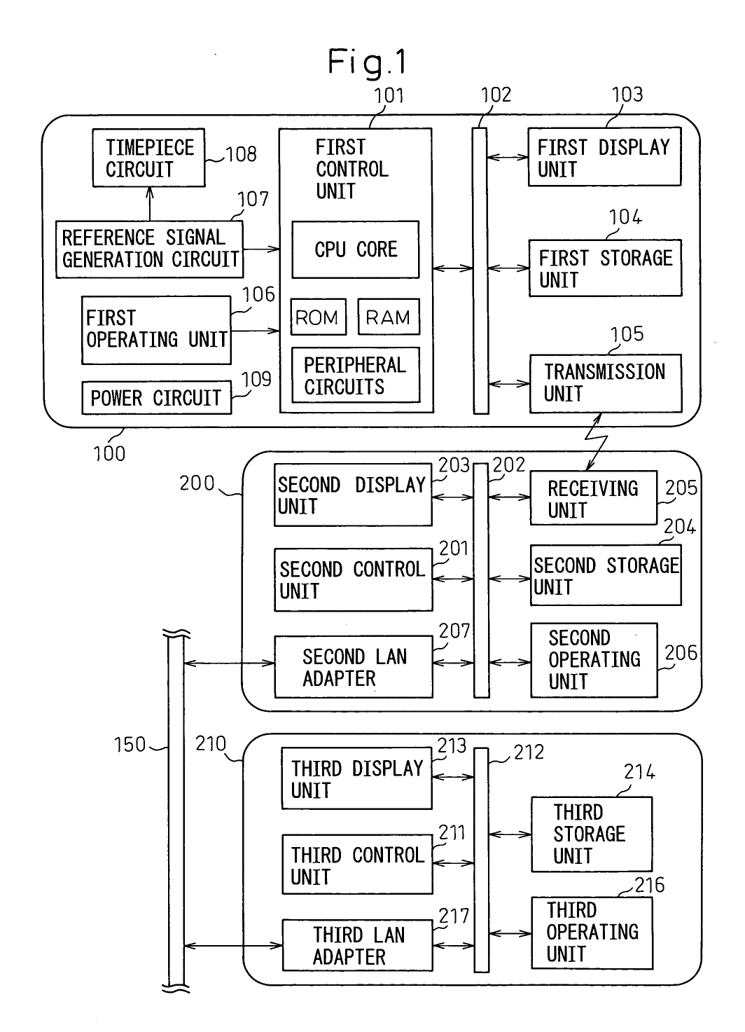

FIG. 1 is a schematic block diagram schematically showing the configurations of a portable electronic device 100, a PC terminal A 200 (master PC), and a PC terminal B 210 (slave PC) that constitute a minimum unit realizing a security system in accordance with the present invention.

The portable electronic device 100 is constructed as a wristwatch. The portable electronic device 100 comprises a control unit 101, a first display unit 103 connected to the control unit 101 over a bus 102, a first storage unit 104 realized with any of various storage media, a transmission unit 105, a first operating unit 106 including a crown that is used to control mainly the activity of a timepiece, a reference signal generation circuit 107, a timepiece circuit 108 that activates the movement of the timepiece, and a power circuit 109.

The control unit 101 operates based on a reference clock sent from the reference signal generation circuit 107 and comprises a CPU core, a read-only memory (ROM) in which programs are stored, a random access memory (RAM) to be used as a work area, and peripheral circuits.

An unique identification data (for example, 16 bits of numerical data) with which the portable electronic device 100 is identified is stored in advance in the storage unit 104. As described later, the control unit 101 allows the transmitting unit 105 to autonomously transmit identification data stored in the storage unit 104 by radio at intervals of a predetermined time (for example, 2 sec).

The portable electronic device 100 is constructed in the form of a wristwatch on the assumption that a manager wears it all the time. However, the portable electronic device 100 may be of a card type of a visiting-card size that is hung on the neck, or of a badge-like nameplate type that is attached to outerwear or the like, or may be constructed like an existing handheld terminal such as a portable cellular phone, a personal digital assistant (PDA), or a compact PC terminal. The size, weight, and form of the portable electronic device are not limited.

The PC terminal A 200 (master PC) comprises a second control unit 201 including a CPU core, a ROM in which programs are stored and a RAM, a second display unit 203 connected to the control unit 201 over a bus 202 and realized with a liquid crystal display or the like, a second storage unit 204 in which identification data or the like is stored, a receiving unit 205 that receives identification data from the portable electronic device 100, a second operating unit 206 realized with a keyboard and a mouse, and a second LAN adapter 207 that transmits or receives data over a LAN 150.

The PC terminal B 210 (slave PC) comprises a third control unit 211 including a ROM in which a CPU core and programs are stored, and a RAM, a bus 212, a third display unit 213 connected to the third control unit 211 over the bus 212 and realized with a liquid crystal display, a third storage unit 214; a third operating unit 126 realized with a keyboard and a mouse, and a third LAN adapter 217 that transmits or receives data over a LAN 150.

When the PC terminal A 200 (master PC) receives proper identification data from the portable electronic device 100, the PC terminal A 200 becomes usable. The PC terminal A 200 transmits an enabling signal to the PC terminal B 210 (slave PC) over the LAN 150. This makes the PC terminal B 210 usable.

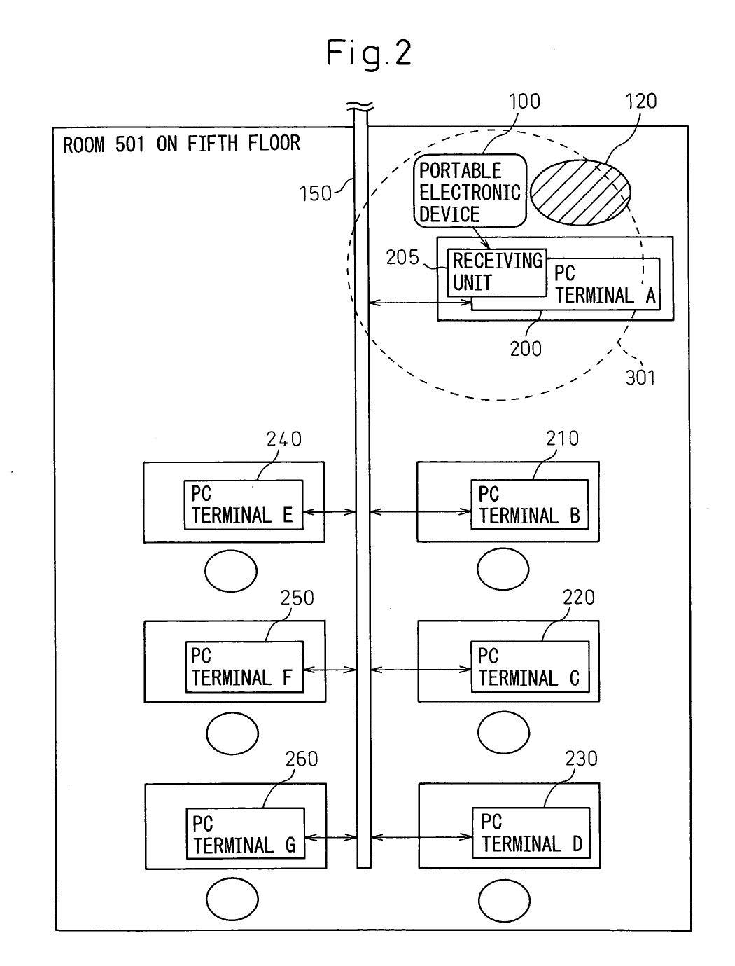

FIG. 2 shows an example of arrangement of PC terminals, in which the security system in accordance with the present invention is adopted, in a room (room 501 on the fifth floor) in which a predetermined section is stationed.

The PC terminal A 200 that communicates with the portable electronic device 100 owned by a manager 120 is connected on the LAN 150. Six PC terminals B 210, C 220, D 230, E 240, F 250, and G 260 belonging to the same section are connected on the LAN 150.

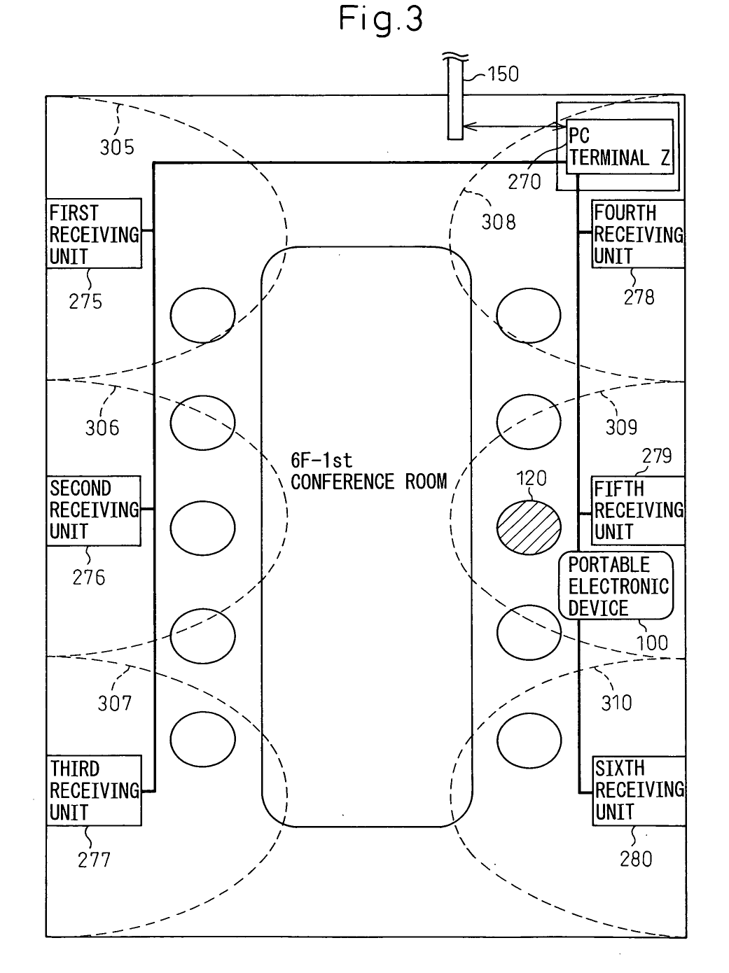

FIG. 3 shows an example of arrangement of PC terminals, to which the security system in accordance with the present invention is adapted, in a predetermined conference room (first conference room on the sixth floor).

A PC terminal Z 270 disposed in the room is connected on the LAN 150 over which the PC terminals A 200 to G 206 are interconnected. First to sixth receiving units 275 to 280 capable of receiving identification data from the portable electronic device are disposed in six places in the room. Furthermore, the first to sixth receiving units 275 to 280 are connected to the PC terminal Z 270.

The PC terminals C 220 to G 260 are configured similarly to the PC terminal B 210 (slave PC), and the PC terminal Z 270 is configured similarly to the PC terminal A 200 (master PC).

The PC terminal A 200 dedicated to the manager 120 includes one receiving unit 205 that receives identification data from the portable electronic device 100. Moreover, the PC terminal Z 270 includes six receiving units 275 to 280 that receive identification data from the portable electronic device 100. Preferably, the receiving units 205 and 275 to 280 are constructed separately from the respective PC terminals, can receive data within receiving zones 301 and 305 to 310 respectively, and are connected to the respective PC terminals via USB ports. However, the receiving unit 205 may be incorporated in the PC terminal A 200. Furthermore, if a receiving condition is poor because of the presence of various articles (display unit, books, and other obstacles), a plurality of receiving units may be interconnected over two or three USB cables. Whichever of the receiving units receives identification data, the identification data may be fetched by the PC terminal A.

The LAN 150 is laid in a required place (other room or a conference room). At least a PC terminal including a receiving unit capable of receiving identification data from the portable electronic device is connected on the LAN 150.

FIG. 3 shows a state in which the manager 120 shown in FIG. 2 has moved to the receiving zone 309 covered by the fifth receiving unit 279 in the first conference room on the sixth floor for the purpose of a conference. In the state shown in FIG. 3, the manager 120 is absent from the room 501 on the fifth floor shown in FIG. 2, and the PC terminals A 200 to G 260 are held unusable.

Moreover, FIG. 2 and FIG. 3 show states in which the manager 120 owns one portable electronic device 100. Alternatively, a plurality of managers may use respective PC terminals and own respective portable electronic devices that share the same identification data. Otherwise, the plurality of managers may use one PC terminal and hold a plurality of portable electronic devices that share the same identification data. For example, in the example shown in FIG. 2, a user who usually uses the PC terminal B 210 may own a sub portable electronic device that, when the manager 120 is absent, can make the PC terminals B 210 to G 260 usable. In this case, the user of the PC terminal B 210 places his/her sub portable electronic device within the receiving zone 301 of the receiving unit 205.

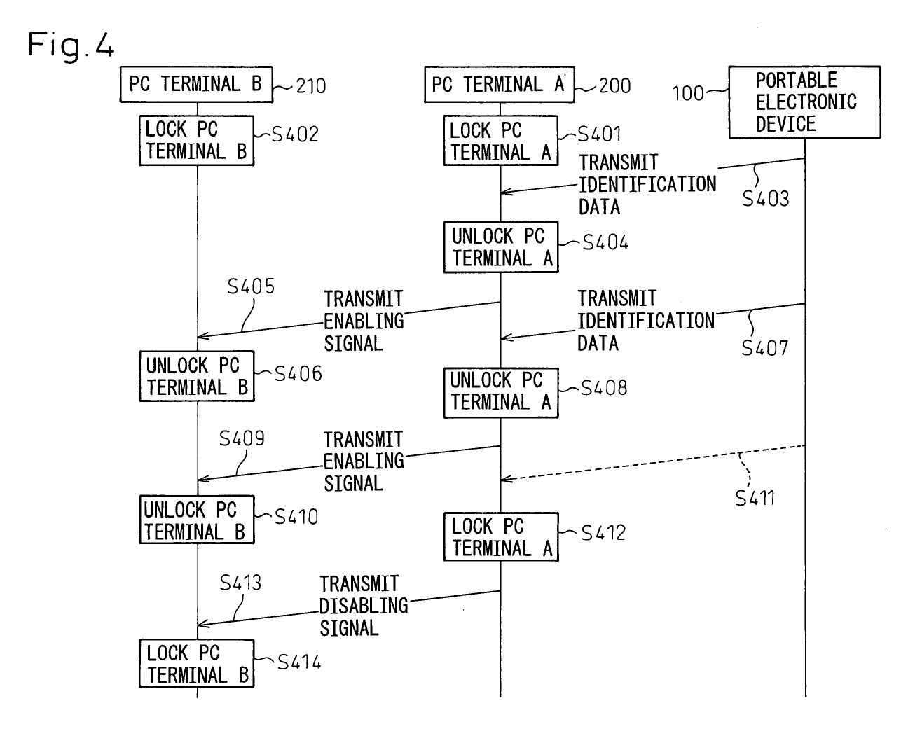

FIG. 4 outlines actions to be performed in the security system in accordance with the present invention.

For convenience, FIG. 4 shows the PC terminal A 200 as if the PC terminal A 200 were managing the use state of the PC terminal B 210 alone. In practice, as shown in FIG. 2, the PC terminal A 200 concurrently manages all of the PC terminals B 210 to G 260.

First of all, the power supply of the PC terminal A 200 is turned on. After the operating system (OS) of the PC terminal A starts up, a master program required for implementing the security system in accordance with the present invention is initiated. Thereafter, according to the master program, the second control unit 201 included in the PC terminal A 200 locks the second operating unit 206 so as to prevent a user from manipulating the second operating unit 206 (S401).

Similarly, the power supply of the PC terminal B 210 is turned on, and the OS thereof starts up. Thereafter, a slave program required for implementing the security system in accordance with the present invention is initiated. Thereafter, according to the slave program, the third control unit 211 included in the PC terminal B 210 locks the third operating unit 216 so as to disable a user from manipulating the third operating unit 216 (S402).

Thereafter, the manager 120 who holds the portable electronic device 100 enters the receiving zone 301 of the receiving unit 205 connected to the PC terminal A 200. The portable electronic device 100 then transmits identification data at intervals of a predetermined time (for example, 2 sec) (S403). The second control unit 201 included in the PC terminal A 200 receives the identification data via the receiving unit 205. After performing authentication that will be described later, the second control unit 201 unlocks the second operating unit 206 (S404).

Thereafter, the second control unit 201 included in the PC terminal A 200 transmits an enabling signal to a network address, which is stored in advance in the storage unit and assigned to the PC terminal B 210, over the LAN 150 (S405). The third control unit 211 included in the PC terminal B 210 having received the enabling signal performs authentication as described later, and then unlocks the third operating unit 216 (S406).

If the manager 120 who owns the portable electronic device 100 stays in the receiving zone 301, the foregoing processing is repeated. The second and third operating units 206 and 216 are kept unlocked. Namely, the PC terminals A 200 and B 210 are kept usable (S407 to S410).

However, when the manager 120 leaves the receiving zone 301, as identification data is not transmitted from the portable electronic device 100 (S411), the second control unit 201 included in the PC terminal A 200 first locks the second operating unit 206. Namely, the second control unit 201 makes the PC terminal A 200 not usable (S412). Thereafter, the second control unit 201 transmits a disabling signal to the PC terminal B 210 over the LAN 150 (S413). The third control unit 211 included in the PC terminal B 210, having received the use disabling signal, locks the third operating unit 216. Namely, the third control unit 211 makes the PC terminal B 210 not usable (S414).

As long as the manager 120 who owns the portable electronic device 100 stays within the receiving zone 301 of the PC terminal A 200, the PC terminals A 200 and B 210 (as well as the PC terminals C 220 to G 260) are kept usable. However, once the manager 120 who holds the portable electronic device 100 leaves the receiving zone 301 of the PC terminal A 200, the PC terminals A 200 and B 210 (as well as the PC terminals C 220 to G 260) are made not usable.

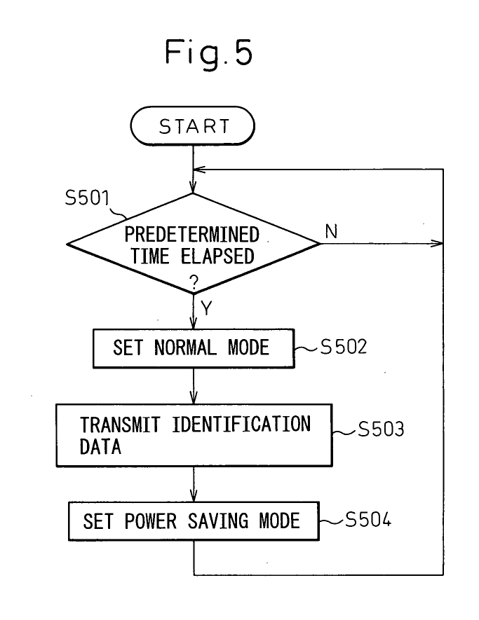

FIG. 5 is a flowchart describing actions to be performed by the portable electronic device 100 as part of the actions outlined in FIG. 4.

The processing described in FIG. 5 is executed by the first control unit 101 included in the portable electronic device 100 according to a program stored in the ROM.

First, the first control unit 101 verifies whether a predetermined time (for example, 2 sec) has elapsed (S501). If the predetermined time has elapsed, the portable electronic device 100 is set to a normal mode (by, for example, canceling a power saving mode that will be described later) (S502). Thereafter, the first control unit 101 transmits the identification data stored in the storage unit 104 from the transmission unit 105 by radio (S503). Thereafter, the first control unit 101 sets the portable electronic device 100 to the power saving mode in which the power consumption of the portable electronic device 100 is saved (for example, power supply to the display unit 103 is stopped) (S504). Control is then returned to step S501.

Preferably, identification data is transmitted from the portable electronic device 100 to the PC terminal A 200 together with a header that specifies the kind of data and a parity bit for use in checking for errors.

Steps S502 and S504 of switching the normal mode and power saving mode need not always be performed. However, especially when the portable electronic device 100 is driven by an internal power supply (battery), switching of the normal mode and power saving mode would prove effective for extending of the service life of a battery.

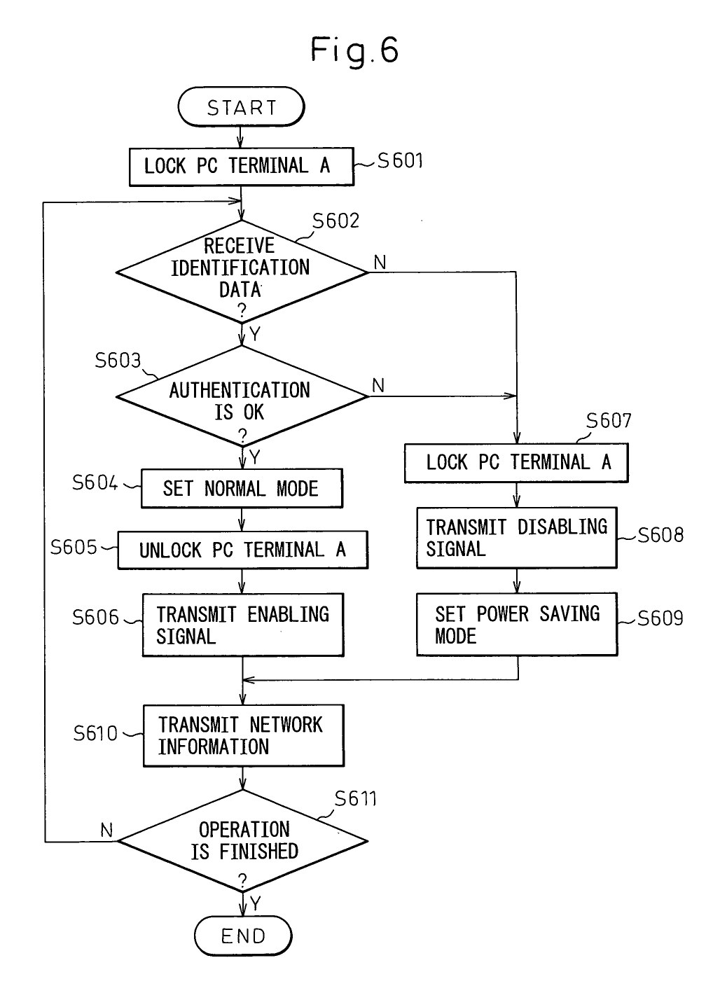

FIG. 6 is a flowchart describing actions to be performed by the PC terminal A 200 as part of the actions outlined in FIG. 4.

The processing described in FIG. 6 is executed mainly by the second control unit 201 included in the PC terminal A 200 according to the master program stored in advance.

The power supply of the PC terminal A 200 is turned on, and the OS thereof starts up. Thereafter, the second control unit 201 locks the second operating unit 206 so as to prevent a user from manipulating the second operating unit 206 (S601).

Thereafter, the second control unit 201 verifies whether identification data is received from the portable electronic device 100 (S602). If the identification data is received within a predetermined time (for example, 2+α sec), the second control unit 201 compares the received identification data with identification data stored in advance in the second storage unit 204 included in the PC terminal A 200, and verifies whether the data items correspond (S603).

If the received identification data corresponds with identification data stored in the storage unit included in the PC terminal A 200, the second control unit 201 sets the PC terminal A 200 to the normal mode (by, for example, canceling the power saving mode that will be described later) (S604). The second operating unit 204 included in the PC terminal A 200 is unlocked (S605). Namely, the PC terminal A 200 is made usable.

Thereafter, the second control unit 201 transmits an enabling signal to the PC terminal B 210 (as well as the PC terminals C 220 to G 260), which is managed by the PC terminal A 200, via the LAN adapter 207 according to a network address stored in advance in the storage unit 204 (S606).

If identification data stored in advance is not received within a predetermined time (for example, 2+α sec) (S602), the second control unit 201 locks the second operating unit 204 included in the PC terminal A 200 (S607). If the second operating unit 206 is already locked, the second control unit 201 keeps the second operating unit 206 locked. Namely, the PC terminal A 200 is kept not usable.

Thereafter, the second control unit 201 transmits a disabling signal to the PC terminal B 210 (as well as the PC terminals C 220 to G 260), which is managed by the PC terminal A 200, according to a network address stored in advance in the storage unit 204 (S608). Thereafter, the second control unit 201 sets the PC terminal A 200 to the power saving mode (power supply to the display unit is ceased) (S609).

Thereafter, the second control unit 201 transmits network information, which comprises the received identification data of the portable electronic device 100 and an ID number (PC-ID) assigned to the PC terminal A 200 (a computer name, an IP address, or a domain name), to the PC terminal B 210 (as well as the PC terminals C 220 to G 260), which is managed by the PC terminal A 200, via the LAN adapter 207 (S610). If the portable electronic device 100 stays in the receiving zone 301, the second control unit 201 transmits as the network information the identification data of the portable electronic device 100 and the ID number of the PC terminal A 200. Furthermore, if the portable electronic device is not located in the receiving zone 301, the second control unit 201 transmits only the ID number of the PC terminal A 200 as the network information.

Thereafter, the second control unit 201 verifies whether a operation on the PC terminal A 200 is finished (S611). If the operation on the PC terminal A 200 is finished, the second control unit terminates processing. Otherwise, the second control unit 201 repeats the steps S602 to S611.

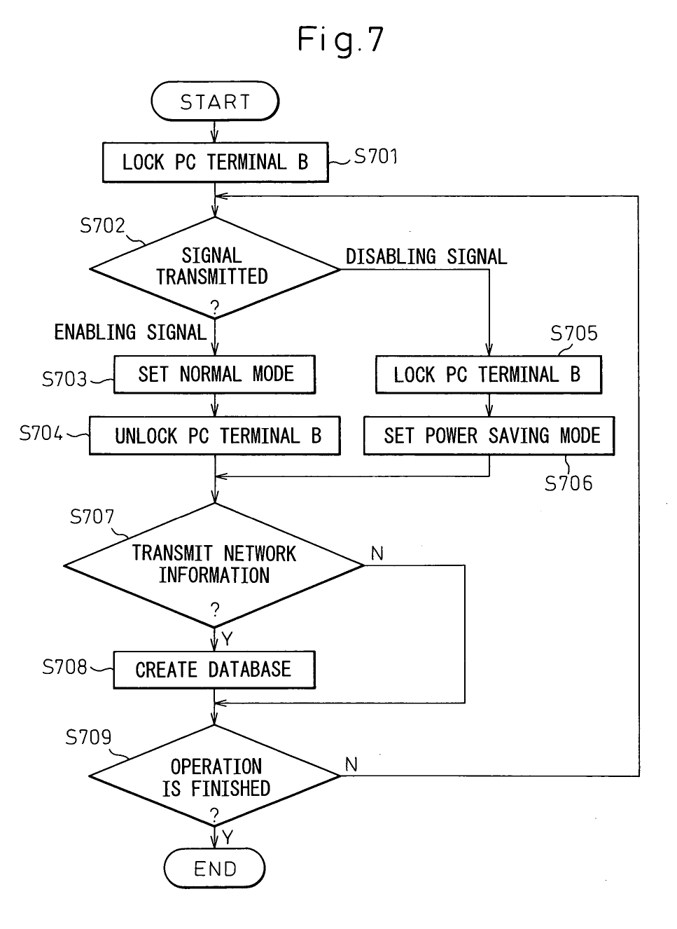

FIG. 7 is a flowchart describing actions to be performed by the PC terminal B 210 as part of the actions outlined in FIG. 4.

The processing described in FIG. 7 is executed by the third control unit 211 included in the PC terminal B 210 according to the slave program stored in advance.

The power supply of the PC terminal B 210 is turned on, and the OS thereof starts up. Thereafter, the third control unit 211 locks the third operating unit 216 so as to disable a user from manipulating the third operating unit 216 (S701).

Thereafter, the third control unit 211 verifies whether an enabling signal or a disabling signal is received from the PC terminal A 200 via the LAN adapter 217 (S702).

If reception of the enabling signal is verified at step 702, the third control unit 211 sets the PC terminal B 210 to the normal mode (by, for example, canceling the power saving mode that will be described later) (S703). The third operating unit 214 included in the PC terminal B 210 is unlocked (S704). Namely, the PC terminal B 210 is made usable.

If reception of the disabling signal is verified at step S702, the third control unit 211 locks the third operating unit 214 included in the PC terminal B 210 (S705). If the third operating unit 214 is already locked, the third control unit 211 keeps the third operating unit 214 locked. Namely, the PC terminal B 210 is held unusable. Thereafter, the third control unit 211 sets the PC terminal B 210 to the power saving mode (power supply to the third display unit 213 is ceased) (S706).

Thereafter, the third control unit 211 verifies whether network information is received via the LAN adapter 217 (S707).

If reception of network information is verified at step S707, the third control unit 211 adds the contents of reception to the network information database (S708). Thereafter, control is passed to step S709. The network information contains at least the identification data of the portable electronic device and the ID number of the PC terminal. Moreover, the third control unit 211 receives network information from all PC terminals (master PCs) that include a receiving unit capable of receiving identification data from the portable electronic device.

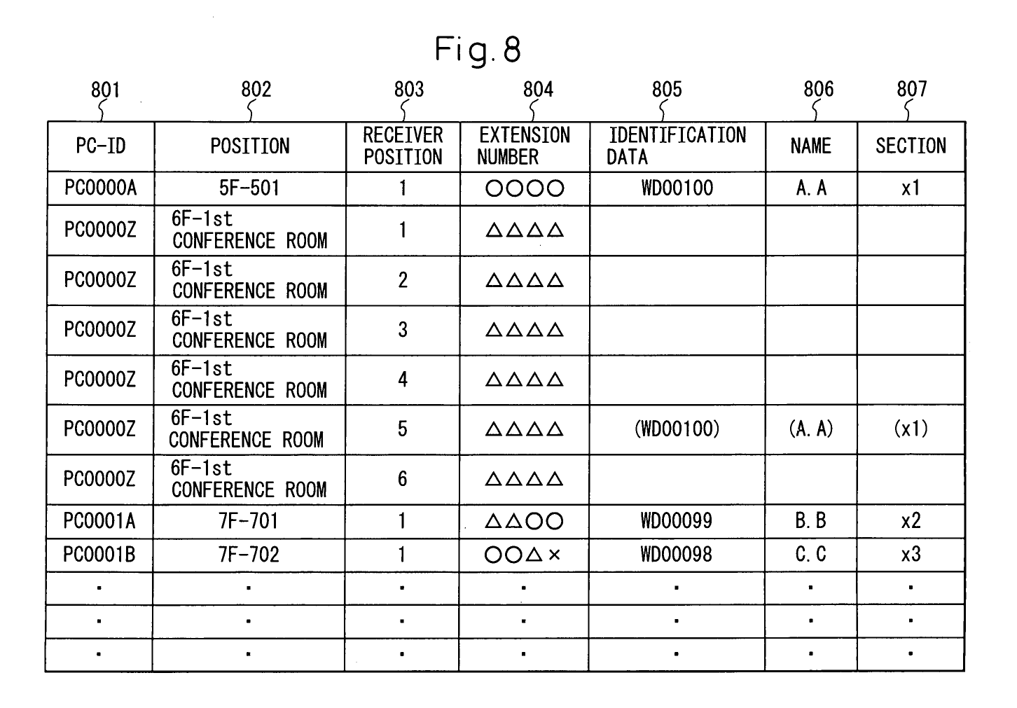

FIG. 8 shows an example of a network information database created in a PC terminal.

The network information database shown in FIG. 8 contains data items 801 of ID numbers of PC terminals, data items 802 of positions of PC terminals, data items 803 of positions of receiving units connected to the PC terminals, data items 804 of extension numbers of telephones installed at the positions of the PC terminals, identification data items 805 of portable electronic devices, data items 806 of names of managers who own the portable electronic devices, and data items 807 of sections to which the managers belong. The network information database shown in FIG. 8 is only an example and may be structured to contain many more kinds of data.

If reception of network information is not verified at step 707, the third control unit 211 verifies whether a operation on the PC terminal B 210 is finished (S709). If the operation on the PC terminal B 210 is finished, the third control unit 211 terminates processing. Otherwise, the third control unit 211 repeats the steps S702 to S708.

The actions performed in the security system as outlined in FIG. 4 include the actions of the portable electronic device 100, PC terminal A 200 (master PC), and PC terminals B 210 to G 260 (slave PCs) described in FIG. 5 to FIG. 7 respectively.

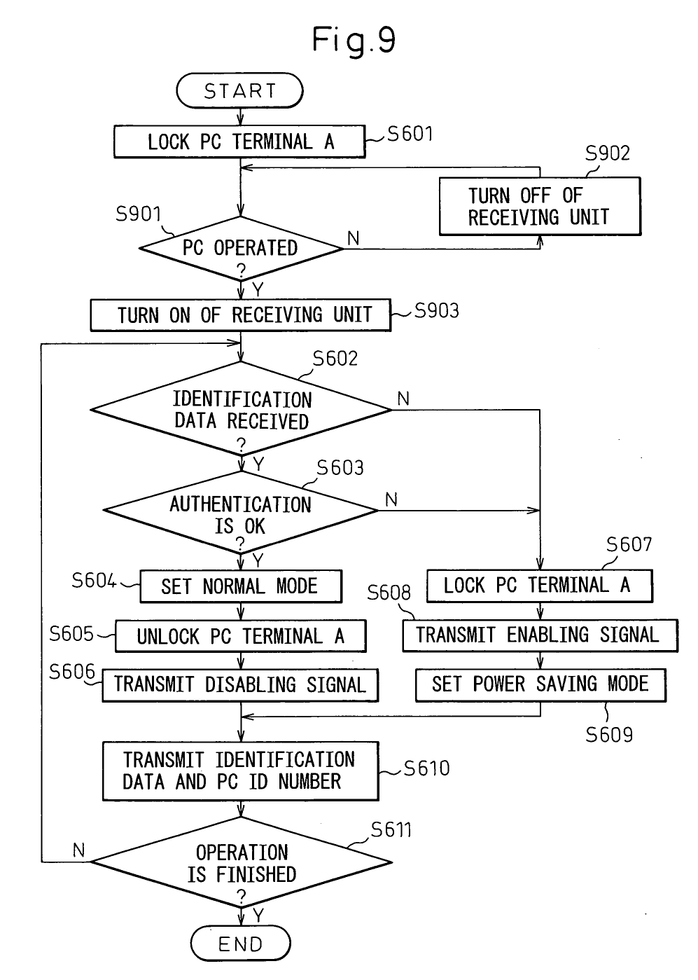

FIG. 9 is a flowchart describing an example of another processing to be performed by the PC terminal A 200 (master PC).

According to the foregoing embodiment, the PC terminal A 200 (master PC) is always in a standby state in which the receiving unit 205 can receive identification data from the portable electronic device. However, when the PC terminal A 200 (as well as the PC terminals B 210 to G 260) is not used, the PC terminal A 200 need not stand by for reception. According to the processing described in FIG. 9, when the manager 120 does not manipulate the second operating unit 206 included in the PC terminal A 200, a power supply to the receiving unit 205 is stopped.

In the control flow described in FIG. 9, the same reference numerals are assigned to steps identical to those included in the control flow described in FIG. 6. The control flow of FIG. 9 is different from that of FIG. 6 in the point that, when the manager 120 does not manipulate the second operating unit 206 included in the PC terminal A 200, a power supply to the receiving unit 205 is stopped for the purpose of power saving. Specifically, the second control unit verifies whether the operating unit 206 included in the PC terminal A 200 has been manipulated (S901). If the second control unit 201 verifies that the operating unit 206 has not been manipulated, the second control unit 201 stops the power supply to the receiving unit 205 (S902). If the second control unit verifies that the operating unit 206 has been manipulated, it initiates power supply to the receiving unit 205 and starts the receiving unit 205 for the first time (S903). According to the processing, unless the manager 120 manipulates the operating unit 206, a power supply to the receiving unit 205 is stopped. The effect of power saving is especially high in case the PC terminal A 200 is realized as a portable notebook computer that is powered from a battery.

According to the foregoing embodiment, the PC terminals B 210 to G 260 (slave PCs) receive network information and create a network information database (see FIG. 8). When the network information database is utilized, if the manager 120 is absent and the PC terminals B 210 to G 260 (slave PCs) are not usable, the destination of the manager 120 can be displayed as a screen saver on the third display unit 213.

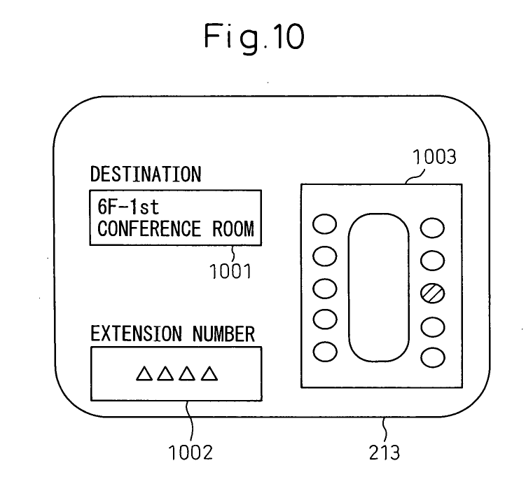

FIG. 10 shows an example of the destination displayed as a screen saver.

The third control unit 211 references the position data 802 to display the destination 1001 of the manager 120 as shown in FIG. 10, and references the extension number data 804 to display an extension number 1002. The third control unit 211 references the receiver position data 803 to display concrete positions 1003 in the first conference room on the sixth floor. Moreover, the concrete positions 1003 in the first conference room on the sixth floor are associated with the receiver positions 1 to 6 that are the positions of the first to sixth receiving units 275 to 280 shown in FIG. 3. A hatched circle among circles representing the positions 1003 represents the destination of the manager 120.

According to the present embodiment, the network information database (see FIG. 8) is created in only the PC terminals B 210 to G 260 (slave PCs). Alternatively, the same network information database (see FIG. 8) may be created in the PC terminals A 200 and Z 270 (master PCs), and a destination may be, similarly to the one shown in FIG. 10, displayed as a screen saver on the display units included in the PC terminals A 200 and Z 270.

For example, when the manager 120 is near the fifth receiving unit 279 shown in FIG. 3, the identification data of the portable electronic device 100 received by the fifth receiving unit 279, the receiver position that is the position of the fifth receiving unit 279, and the ID number of the PC terminal Z are transmitted to the PC terminal A 200 shown in FIG. 2 over the LAN 150. The PC terminal A 200 displays, as shown in FIG. 10, the destination of the manager 120 according to the received information.

Furthermore, according to the aforesaid embodiment, the PC terminals B 210 to G 260 (slave PCs) receive network information and create the network information database (see FIG. 8). By utilizing the network information database, the destination of the manager 120 can be searched.

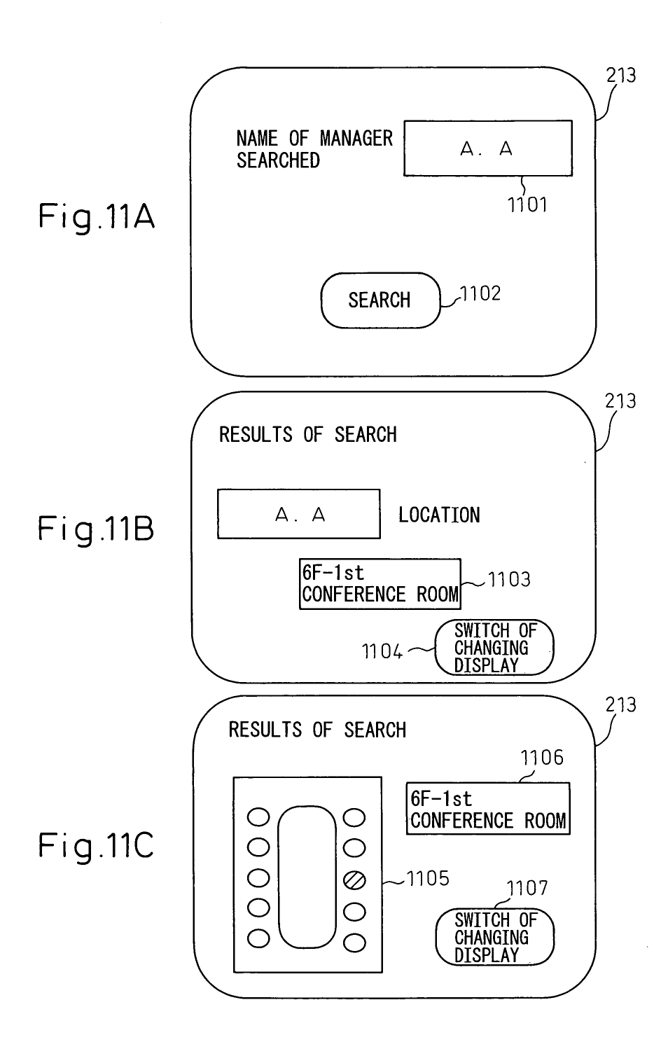

FIG. 11A shows an example of a manager search screen image displayed on the display unit 213 of the PC terminal B 210. In the image shown in FIG. 11A, a predetermined name is entered in Name of Manager Searched 1101, and a Search button 1102 is clicked. The network information database shown in FIG. 8 is referenced in order to display a results-of-search screen image similar to the one shown in FIG. 11B or FIG. 1C. In FIG. 11B, the name 1103 of the destination of the manager searched is displayed by referencing the position data 802. In FIG. 1C, the name 1106 of the destination of the manager searched is displayed by referencing the receiver position data 803. Furthermore, when a Switch of Changing Display button 1104 or 1107 shown in FIG. 11B or FIG. 11C is clicked, the screen images are switched.

Furthermore, according to the aforesaid embodiment, the portable electronic device 100 includes the display unit. When the portable electronic device is, for example, of a card type of a visiting-card size or of a badge-like nameplate type, the display unit need not always be included.

Furthermore, according to the aforesaid embodiment, the PC terminal A 200 having the receiving unit incorporated therein receives identification data from the portable electronic device 100. However, a receiving side need not always be a personal computer. Namely, the receiving-side device could merely comprise a control unit, a receiving unit, a LAN adapter, and a storage unit, and have the abilities to receive identification data, to perform authentication, to transmit a use disabling signal or a use enabling signal, and to transmit identification data and an ID number of a PC terminal. The receiving-side device need not always include a display unit and an operating unit. For example, if a manager does not use a personal computer to work on data, the employment of the receiving-side device contributes to reduction in a cost and reduction in an installation space. Moreover, the security system in accordance with the present invention may be utilized for the purpose of monitoring the locations of kindergarten children or roaming elderly persons. In this case, receiving units can be installed all over the premises of a kindergarten or a nursing home.

1. A security system comprising:
a portable electronic device including a first storage unit in which an unique identification data is stored, and a first transmission unit that transmits the identification data; and
information device including a receiving unit that receives the identification data from the portable electronic device, a second transmission unit that transmits data over a network, a second storage unit in which predetermined identification data and an address of the other information device are stored, and a control unit that transmits an enabling signal to the address over the network when the identification data corresponds with the predetermined identification data.

2. The security system according to claim 1, wherein the information device further includes an operating unit for operating the information device, and
the control unit starts the receiving unit in response to an operation performed on the operating unit.

3. The security system according to claim 1, wherein the second storage unit further stores an identifying information of the information device, and
the control unit controls the second transmission unit so as to transmit an identifying information of the information device; and the identification data to the address over the network.

4. The security system according to claim 1, wherein the information device further includes a display unit and a second receiving unit that receives information of the portable electronic device over the network and
the control unit displays the information of the portable electronic device received by the second receiving unit on the display unit when the identification data received by the receiving unit does not correspond with the predetermined identification data.

5. The security system according to claim 1, wherein the other information device includes a third receiving unit that receives an identifying information of the information device and the identification data over the network, a third storage unit, and a second control unit that stores the received identifying information of the information device in association with the received identification data in the third storage unit.

6. The security system according to claim 5, wherein the second control unit keeps the other information device not usable when the enabling signal is not received.

7. The security system according to claim 6, wherein the other information device further includes a second display unit and
the second control unit displays the information of the portable electronic device based on the received identification data on the second display unit when the other information device is not usable.

8. A portable electronic device comprising:
a first storage unit in which an unique identification data is stored; and
a first transmission unit that transmits the identification data to information device including a receiving unit that receives the identification data from the portable electronic device, a second transmission unit that transmits data over a network, a second storage unit in which predetermined identification data and an address of the other information device are stored, and a control unit that transmits an enabling signal to the address over the network when the identification data corresponds with the predetermined identification data.

9. The portable electronic device according to claim 8, wherein the information device further includes an operating unit for operating the information device, and
the control unit starts the receiving unit in response to a operation performed on the operating unit.

10. The portable electronic device according to claim 8, wherein the second storage unit further stores an identifying information of the information device, and
the control unit controls the second transmission unit so as to transmit the identifying information of the information device; and the identification data to the address over the network.

11. The portable electronic device according to claim 8, wherein the information device further includes a display unit and a second receiving unit that receives information of the portable electronic device over the network and
the control unit displays the information of the portable electronic device received by the second receiving unit on the display unit when the identification data received by the receiving unit does not correspond with the predetermined identification data.

12. The portable electronic device according to claim 8, wherein the other information device includes a third receiving unit that receives the identifying information of the information device and the identification data over the network, a third storage unit, and a second control unit that stores the received identifying information of the information device in association with the received identification data in the third storage unit.

13. The portable electronic device according to claim 12, wherein the second control unit keeps the other information device not usable when the enabling signal is not received.

14. The portable electronic device according to claim 13, wherein the other information device further includes a second display unit and
the second control unit displays the information of the portable electronic device based on the received identification data on the second display unit when the other information device is not usable.

15. A security method among a potable electronic device, a first information device and a second information device, the method comprising the steps of:
transmitting an identification data in the potable electronic device;
receiving the identification data in a receiving unit of the first information device; and
transmitting an enabling signal to the second information device over a network according to a stored address when the receiving identification data corresponds with a predetermined identification data, in the first information device.

16. The security method according to claim 15,
wherein the first information device includes an operating unit,
the method further comprising the step of starting the receiving unit in response to an operation performed on the operating unit, in the first information device.

17. The security method according to claim 15, the method further comprising the step of transmitting an identifying information of the first information device to the second information device over the network according to the stored address, in the first information device.

18. The security method according to claim 15,
wherein the first information device includes a display unit,
the method further comprising the step of displaying the information of the potable electronic device transmitted the received identification data on the display unit when the received identification data does not correspond with the predetermined identification, in the first information device.

19. The security method according to claim 15, the method further comprising the step of receiving an identification information of the first information device and the identification data over the network, in the second information device.

20. The security method according to claim 19, the method further comprising the step of keeping the second information device not usable when the enabling signal is not received from the first information device, in the second information device.
